(19) United States
(12) Patent Application Publication
(10) Pub. No.: US 2009/0110795 A1
(43) Pub. Date: Apr. 30, 2009

(54) FOOD PORTIONS FOR SNACK TRAYS

(76) Inventors: Rod Poziwilko, Bois D'Arc, MO (US); Dennis J. Childress, Monet t, MO (US)

Correspondence Address: BRINKS HOFER GILSON & LIONE, P.O. BOX 10395, CHICAGO, IL, 60610, US

(21) Appl. No.: 11/923,144

(22) Filed: Oct. 24, 2007

(51) Int. Cl. B65B 25/06; A23L 1/00

(52) U.S. Cl. 426/531; 426/392

(57) ABSTRACT

A snack-slice loaf of a food product and a method for providing food portions for snack trays in which the snack-slice loaf may include multiple overlying subunits. The overlying subunits are produced by sectioning a food block using cutting and sub-cutting, or perforation. The sectioned subunits can directly be placed into a food receptacle adapted to receive the sectioned subunits, without adding or subtracting food layers. The sectioned subunits may include stacks of processed cheese.

### TECHNICAL FIELD

This invention relates to food products and to a method for providing food portions for snack trays.

### BACKGROUND

An important aspect of the food market is related to packaging for the food products. Single serving packages that provide average or typically sized servings of a food or snack are increasingly popular. These packages can not only remain sealed until just prior to consumption thereby eliminating sanitation concerns, but also avoid problems associated with leftovers, storage, and spoilage and waste of the leftover food product. Such single serving packaging includes dairy products, salads, entrees, cookies, crackers, fruit, and the like. Foods compatible from a storage temperature standpoint such as meat and cheese may be combined in one package with other less storage temperature sensitive snacks, such as cookies, crackers or candy. To achieve efficient packaging, separability of food items and rapid access to individual portions is desirable.

In the food industry it is well known to package a plurality of substantially identically shaped product slices within an enclosure. However, in handling certain food items, such as comestibles like cheese and meat, difficulty has been encountered in separating one slice from another. This problem is particularly acute in fast food service restaurants, where rapidity and ease of separability of a product, such as cheese, is extremely desirable.

### BRIEF SUMMARY

This invention provides a snack-slice loaf of a food product. The loaf includes a food block having a predetermined number of overlying subunits, each subunit including a number of overlying food layers and characterized by a stack height, where each subunit is off-set with respect to adjacent subunits, such that alternating edges extend laterally outward relative to adjacent subunits. The subunits may include sectioned subunits having predetermined external dimensions, where the predetermined external dimensions and the stack height of each sectioned subunit correspond with the dimensions of a food receptacle adapted to receive the sectioned subunits.

This invention provides a method of preparing food portions. The method includes providing a food block having a predetermined number of overlying subunits, where each subunit includes a number of overlying food layers characterized by a stack height, and where each subunit is off-set with respect to adjacent subunits, such that alternating edges extend laterally outward relative to adjacent subunits. The food block may be cut into sectioned subunits and the food block may be packaged. The stack height of each sectioned subunit is such that each sectioned subunit may be removed from the food block by grasping an edge of the sectioned subunit and directly placing the sectioned subunit into a food receptacle adapted to receive the sectioned subunits, without adding or subtracting food layers therefrom.

### BRIEF DESCRIPTION OF THE DRAWINGS

FIG. 1 is an image of a wire harp (bottom) and a cutting block (top) that can be used to manually cut a food block.

FIG. 2 is an image of two sets of sub-cutters and one set of regular cutters of the food block in accordance with an aspect of the invention.

FIG. 3 is a perspective side view of a food block in accordance with an aspect of the invention that includes a stack of eight overlying subunits.

FIG. 4 is a perspective top view of a food block that includes a stack of eight overlying subunits in accordance with an aspect of the invention.

FIG. 5 is a perspective side view of a food block in accordance with an aspect of the invention that includes a stack of six overlying subunits with one sectioned subunit removed.

FIG. 6 is a perspective side view of a food block in accordance with an aspect of the invention that includes a stack of six overlying subunits, where the loaf is wrapped in transparent film.

### DETAILED DESCRIPTION

The practice of the present invention employs, unless otherwise indicated, conventional techniques in the food industry, which are within the skill of art.

The terms “a”, “an”, “the” and the like, unless otherwise indicated, include plural forms.

The term “loaf” refers to a shaped or molded often symmetrical mass of food. For example, a loaf of cheese can have a substantially rectangular shape. The loaf can include a food block, for example casted cheese. Alternatively, the loaf can have a number of overlying subunits. The overlying subunits in a loaf according to this invention are typically arranged in a symmetrical fashion. The overlying subunits can be stacked. The overlying subunits can be stacked in such a way so as to provide easy access to the subunits and easy separation and removal of the subunits from the loaf.

The term “casting belt” means a conveyor belt or other means suitable for supporting a cast food product. The casting belt may be chilled or cooled.

The term “sub-cutter” means a cutter that is used for sub-cutting, which can be forming a perforation of a food block. For example, during the step of sub-cutting casted cheese, the sub-cutter cuts only partially through the casted sheet of cheese, thus creating a “sub” cut, such as a perforation, as opposed to entirely cutting through the loaf of cheese.

Food products such as processed cheese may present some difficulties in cutting or slicing because such material tends to cling to the cutting surfaces. For this reason, such a material can be melted and extruded into a thin sheet upon a surface such as a moving casting belt. In such a process, molten cheese is fed into a manifold, which distributes the molten cheese in a layer onto a continuously moving endless belt, which is commonly called a casting belt. Such a process, and the apparatus used in such a process, is described, for example, in U.S. Pat. Nos. 5,527,551, 5,573,805, and 6,797,306, which are incorporated by reference herein.

Generally, in accordance with various features of the present invention, food portions are provided in the form of a snack-slice loaf of a food product. Preferably, the food product is processed cheese. The cheese may be casted cheese. The casted cheese product may be cut to smaller sized units using a cutter, for example a wire harp. The smaller sized units may be suitable for individual snack portions. The smaller size units may be removed from the overall package and placed into trays or other containers. The steps of cutting the food product and removal of the sectioned subunits can be manual, automated, or a mixture of both manual and automated cutting and/or removal.

One advantage of the present invention is that the user can remove the exact amount needed rather than having to count each individual layer before peeling a complete portion from the overall loaf. By using stacks of overlying layers with offsetting portions, it is thus possible to remove food portions that have predefined number of layers, with predefined size, predefined volume, or predefined amount of food, and fill containers quicker than having to count, separate, and pick individual food layers.

The snack-slice loaf may include alternating edges of the subunits that extend laterally outward a distance sufficient such that the edges can be grasped and the sectioned subunits can be removed from the snack-slice loaf. The snack-slice loaf may include two to ten overlying subunits. Preferably, the snack-slice loaf includes six overlying subunits.

The snack-slice loaf may include a loaf having a weight of about 2000 grams to about 2200 grams. The snack-slice loaf may or may not be wrapped in a hermetically sealed package.

The number of food layers in each stack can vary and will depend on the thickness of the layers and on the desired snack portion size. In the case of casted cheese, typically the number of cheese layers in each stack can range from one to about ten. Preferably, in an embodiment directed to a loaf based on casted cheese, the number of cheese layers in each stack is five. Such cheese layers can be formed in a variety of ways, for example using roller manifolds, as described in U.S. Pat. No. 6,797,306, which is incorporated by reference herein. Optionally, to prevent their sticking together, produced cheese layers can be treated in ways described in U.S. Pat. No. 3,900,574, which is incorporated by reference herein.

In one preferred embodiment, the overlying food layers may include cheese layers. Providing a food block may include providing a rectangular-shaped block having a relatively long side and a relatively short side. Cutting the block into sectioned subunits may include cutting the block in a direction substantially parallel to the relative short side.

Providing a food block may include providing overlying subunits having a perforation line in the overlying food layers of each subunit that is substantially parallel to the relatively long side. The perforation may be medial.

Providing a food block may include providing a food block having two to ten overlying subunits. Preferably, providing a food block includes providing a food block having six overlying subunits.

Directly placing the sectioned subunit into a food receptacle may include placing the sectioned subunit into a thermoformed tray. Directly placing the sectioned subunit into a food receptacle may include placing the sectioned subunit into a bin.

The examples described herein are provided to illustrate, but not to limit the claimed invention. Snack size portions according to this invention were prepared using casted cheese loaves that were manually cut (harped) as indicated below. Loaves with stacks of six, seven, and eight subunits were examined. In some experiments, the loaves were manually wrapped.

The method of providing food portions may include the step of cutting the food blocks. The food blocks can be cut in a variety of ways, for example using cheese cutters and cheese cutter systems known in the art. Some of these can be obtained, for example, from General Machinery Corporation, Sheboygan, Wis. The food blocks can be cut manually or they can be cut in an automated way. Preferably, the food blocks are cut using a cutting harp, also known as wire harp or cheese harp. Cutting can be performed, for example, using a cutting harp with approximately 4 cm spacing between two adjacent wires used for cutting.

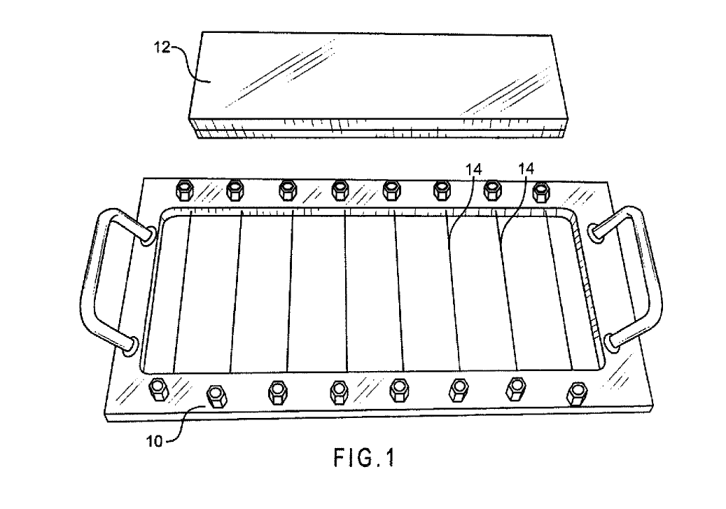

FIG. 1 shows an image of a wire harp 10 (bottom) and a cutting block 12 (top) that can be used to cut food blocks. In this example, the spacing between two adjacent wires 14 of the wire harp 10 was approximately 4.13 cm. A Delrin cutting block, made of food grade plastic, and approximately 1″ thick, was used to elevate the product so as to manually cut entirely through a block made of casted cheese.

Once cutting of the food block is performed, the method may include the step of sub-cutting (perforation). Sub-cutting of the food block into subunits may be performed by generating a perforation line in the overlying food layers of each subunit that is substantially parallel to the relatively long side. The sub-cutting (perforation) may be medial, such as in the middle of the loaf, in a line that is substantially parallel to the relatively long side of the food block.

Sub-cutting can be performed in a variety of ways. For example, sub-cutting can be performed using a sub-cutter that has two cutters per arm. Regular cutters typically have only one cutter per arm. On the sub-cutter sets, one cutter (for example, a cutting disk) can be slightly smaller than the other, allowing it to cut only partially through the casted sheet of cheese, thus creating a “sub” cut.

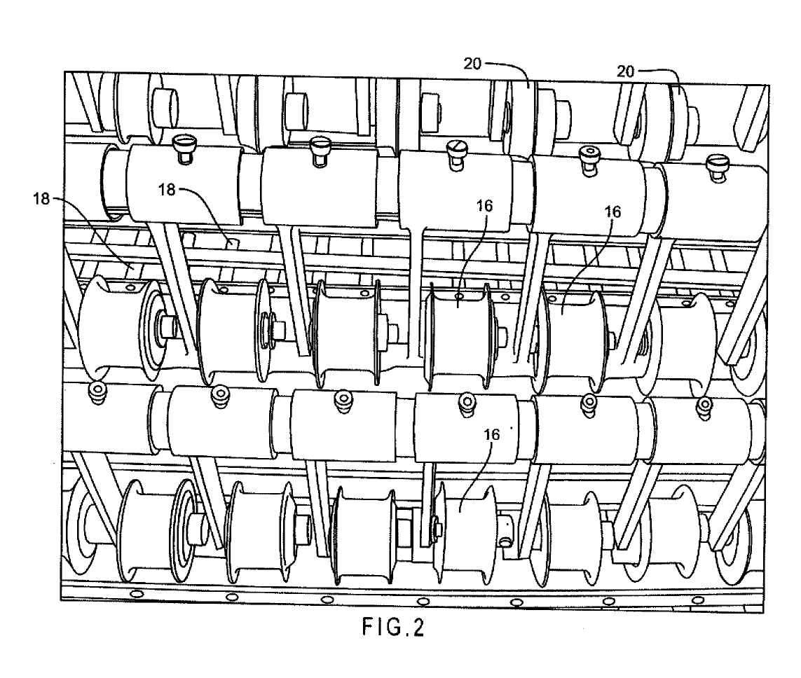

FIG. 2 is an image of two sets of sub-cutters and one set of regular cutters. In this example, the sub-cutters 16 have two round cutters per arm 18. The regular cutters 20 have only one cutter per arm 18. In this example, on the sub-cutter sets 16, one cutting disk is slightly smaller than the other, allowing it to cut only partially through the casted sheet of cheese, thus being referred to as the “sub” cut.

It is also possible to first perform the perforation, and then perform the cutting of the food block. Generally, what is needed for practicing the invention is to cut the food block such that food portions (pieces) of desired size can relatively easily and rapidly be separated from the loaf.

The size of the food pieces can vary. The size of the food pieces can be changed by making desired cuts in a food block with the cutter 20 and with the sub-cutter 16. A preferred size of the food pieces will correspond to the desired portion size. The shape of the pieces can vary and can be, for example, rectangular, square, triangular, trapezoid, or circular. For example, in one embodiment the preferred size of the individual food pieces is square, with dimensions of approximately 4 cm (length)×4 cm (width) x stack height. The stack height is determined by the number of individual food layers that are laid on top of each other.

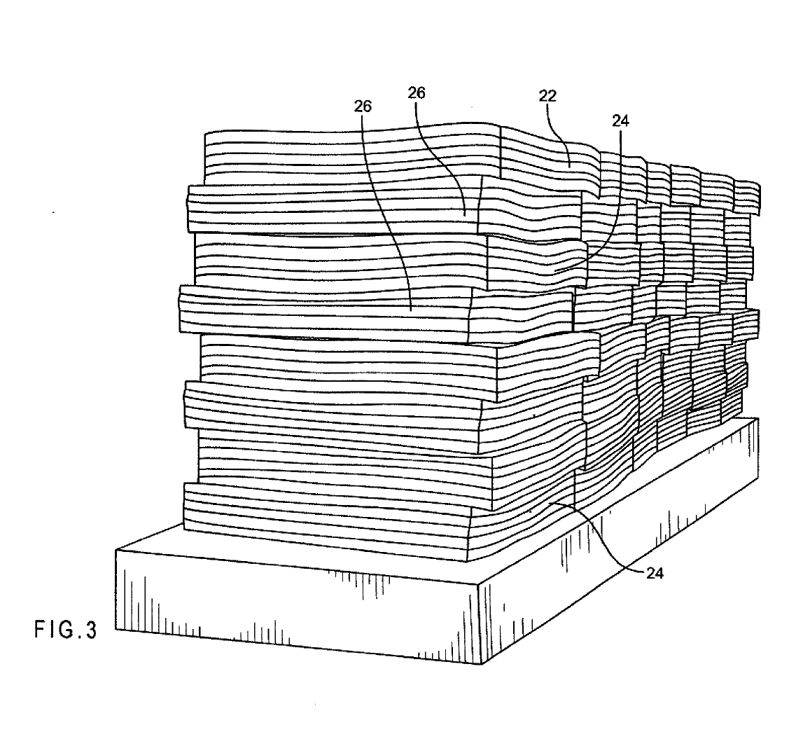

The method may include staggering (offsetting) the lateral edges of overlying subunits (stacks) 22 relative to one another, as shown in FIG. 3. The lateral edges of alternating stacks may be positioned in alignment with one another. The stacks may be of substantially uniform size and thickness. In the examples shown in FIGS. 3-6, using casted cheese, the stacks include parallel side edges along the relatively long side 24, and parallel end edges along the relatively short side 26 disposed perpendicularly with respect to side edges 24. As seen in FIGS. 3-6, a stack of slices 22 includes a first group of stacks that is offset to one side, and a second group of stacks that is offset to the opposite side of the food block. The parallel end edges along the relatively short side 26 are positioned in vertical alignment with one another, while the parallel side edges along the relatively long side 24 are positioned in vertical alignment with one another with respect to the first group of stacks, and in parallel offset relationship with respect to the side edges of the second group of stacks that is offset to the opposite side of the food block.

With this arrangement, a series of offset manually graspable lifting portions 30 are provided at opposite sides of the food block and the edges of the stacks 22 project outwardly from an adjacent underlying stack a sufficient amount to enable the uppermost stacks to be readily separated from the remaining stacks.

Offset stacking can be performed in a variety of ways using methods known in the art. For example, offset stacking can be performed using bars, using ribbon guide members as described in U.S. Pat. No. 4,046,923, which is incorporated by reference herein, or combinations thereof. Preferably, offsetting of the stacked layers is performed using an “easy pick bar” (EZ pick bar). The EZ Pick bar is a straight piece of stainless, which is grooved approximately 8.6 cm in width and offset to provide the EZ pick layering as the loaf is built. It is possible to change the dimensions of the ribbon guide members, of the offsetting bars, and of the easy pick bar, thereby changing the extent of offset between alternating stacks. To maximize the ease of separability of the stacks, it is desirable that the stacks extend outwardly as far as possible from the edge of the adjacent slice. However, particularly with a flexible and plastic product such as cheese, if the offset is too large, undesired sagging of the offset portions can occur.

FIG. 3 is an image of an exemplary food block in the form of a stack with eight overlying subunits. As illustrated in the embodiment of FIG. 3, each overlying subunit consists of five individual layers of cheese having a height of approximately 1.37 cm. The overlying subunits are offset with respect to each other. The overall stack height of this food block (loaf) is approximately 11 cm (eight overlying subunits of 1.37 cm height each). The overall length of this loaf is approximately 28.9 cm.

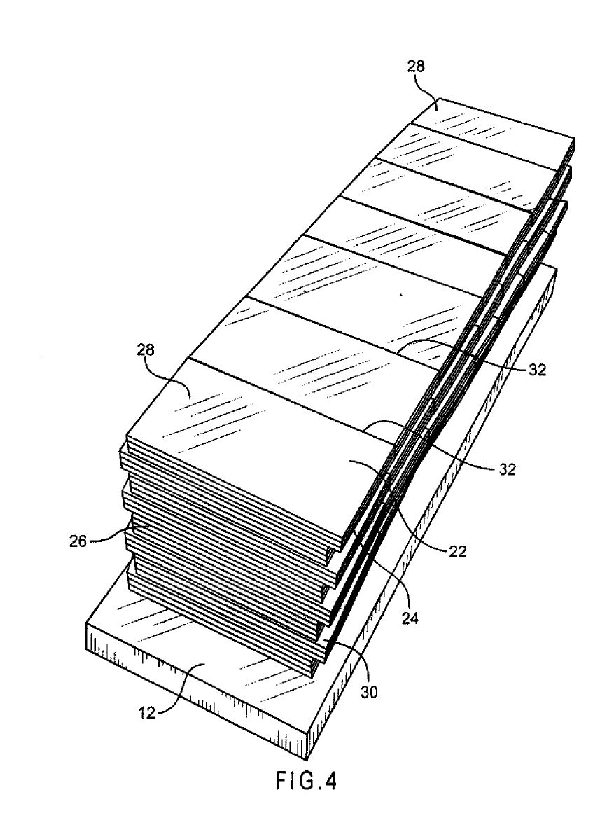

FIG. 4 shows a top view of an exemplary food block in the form of a stack with eight overlying subunits. In this view the cuts 32 obtained during the cutting step can be seen. In this example, six cuts 32 were made in order to obtain seven sections of stacks 22. Sub-cutting (perforation) was performed longitudinally, through approximately the center 28 of the food block, to obtain a medial perforation line, resulting in a total of 112 stacks, or food portions (14 food portions in an individual layer×8 layers).

The method may include removal of the subunits (stacks) from the loaf. The size of the subunits can vary depending on the desired application and snack size. Once cut and perforated, the subunits can easily be manually removed. Alternatively, the subunits can be removed in an automated way.

Sub-cutting (perforation) of the food block provides for relatively easy separation of the stacks from the rest of the food block. That way, the snack-slice loaf maintains integrity, which can be advantageous during shipping and storage, yet it remains easy to remove sectioned subunits from the snack-slice loaf. Sub-cutting (perforation) may be performed in a direction that is perpendicular to the direction of the cutting.

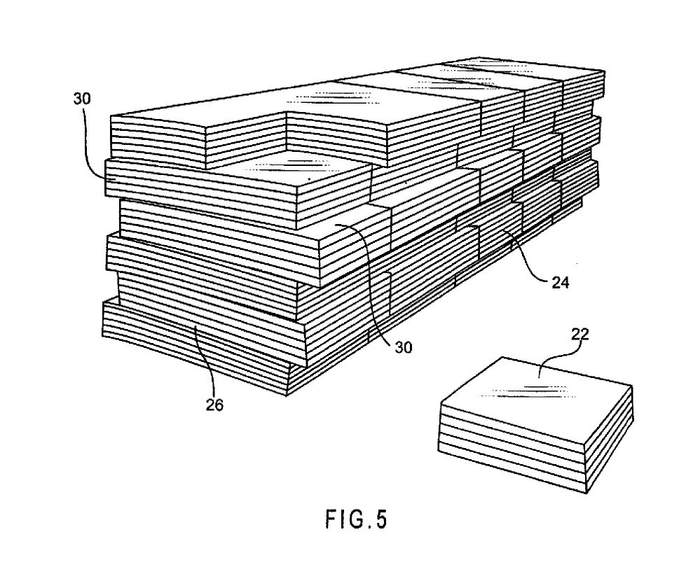

FIG. 5 shows an exemplary food block with six overlying subunits, where one stack, or one of the portions, has been removed to illustrate easy removal. Portion size in this example is approximately 4.13 cm (length)×4.13 cm (width)×1.37 cm (height). The loaf weight is approximately 2095 grams.

The method may include placing the sectioned subunit into a food receptacle designed to accept the sectioned subunits without adding or subtracting food layers. For example, that may include directly placing the sectioned subunit, or food portion, into a receptacle such as a thermoformed tray, plastic bag, plastic container, styrofoam container, bin, and the like. Alternatively, directly placing the sectioned subunit into a food receptacle may include placing the sectioned subunit into a bin.

The method can further include wrapping the entire loaf in a wrapping material that is suitable for wrapping food products. For example, the loaf may be wrapped using transparent film. The wrapping material may be used to hermetically seal the loaf.

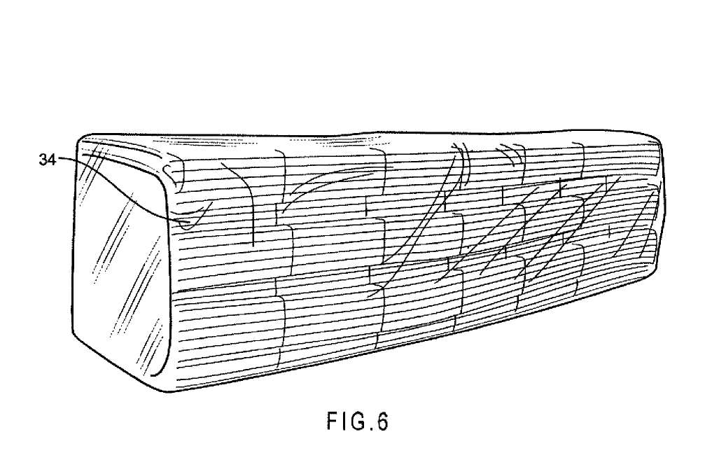

FIG. 6 is an image of a wrapped loaf stack that has six overlying subunits. In this example, a loaf processed according to this invention is wrapped using transparent film 34.

Production of cheese loafs with a height of multiple overlying subunits can become challenging, due to the possible instability of the individual cheese stacks, in particular in the areas 32 that have been cut with a cutter. The number of subunits will depend on the thickness (height) of an individual subunit, the density and consistency of the cheese, and other factors known in the art.

It is to be understood that this invention is not limited to the particular devices, methodology, protocols, products, or reagents described, and as such may vary. It is also to be understood that the terminology used herein is for the purpose of describing particular embodiments only, and is not intended to limit the scope of the present invention, which is limited only by the claims. Other suitable modifications and adaptations of a variety of conditions and parameters normally encountered in the food industry are within the scope of this invention. All publications, patents, and patent applications cited herein are incorporated by reference in their entirety for all purposes.

1. A snack-slice loaf of a food product comprising:
a food block having a predetermined number of overlying subunits, each subunit comprising a number of overlying food layers and characterized by a stack height,
wherein each subunit is offset with respect to adjacent subunits, such that alternating edges extend laterally outward relative to adjacent subunits,
wherein the subunits comprise sectioned subunits having predetermined external dimensions, and
wherein the predetermined external dimensions and the stack height of each sectioned subunit substantially correspond with the dimensions of a food receptacle adapted to receive the sectioned subunits.

2. The snack-slice loaf of claim 1, wherein the alternating edges of the subunits extend laterally outward a distance sufficient such that the edges can be grasped and the sectioned subunits can be removed from the snack-slice loaf.

3. The snack-slice loaf of claim 1, wherein the snack-slice loaf comprises two to ten overlying subunits.

4. The snack-slice loaf of claim 1, wherein the snack-slice loaf comprises six overlying subunits.

5. The snack-slice loaf of claim 1, wherein the snack-slice loaf comprises a loaf having a weight of about 2000 grams to about 2200 grams.

6. The snack-slice loaf of claim 1, wherein the snack-slice loaf further comprises a wrapping that forms a hermetically sealed package.

7. A method of preparing food portions comprising:
providing a food block having a predetermined number of overlying subunits, each subunit comprising a number of overlying food layers and characterized by a stack height,
wherein each subunit is off-set with respect to adjacent subunits, such that alternating edges extend laterally outward relative to adjacent subunits,
cutting the block into sectioned subunits, and
packaging the food block,
wherein the stack height of each sectioned subunit is such that each sectioned subunit can be removed from the food block by grasping an edge of the sectioned subunit and directly placing the sectioned subunit into a food receptacle adapted to receive the sectioned subunits, without adding or subtracting food layers therefrom.

8. The method of claim 7, wherein the overlying food layers comprise cheese layers.

9. The method of claim 7, wherein providing a food block comprises providing a rectangular-shaped block having a relatively long side and a relatively short side, and wherein cutting the block into sectioned subunits comprises cutting the block in a direction substantially parallel to the relative short side.

10. The method of claim 9, wherein providing a food block comprises providing subunits having a medial perforation line in the overlying food layers of each subunit that is substantially parallel to the relatively long side.

11. The method of claim 10, wherein the perforation line is a medial perforation line.

12. The method of claim 7, wherein providing a food block comprises providing a food block having two to ten overlying subunits.

13. The method of claim 7, wherein providing a food block comprises providing a food block having six overlying subunits.

14. The method of claim 7, wherein directly placing the sectioned subunit into a food receptacle comprises placing the sectioned subunit into a thermoformed tray.

15. The method of claim 7, wherein directly placing the sectioned subunit into a food receptacle comprises placing the sectioned subunit into a bin.

16. A snack-slice loaf of a food product comprising:
a food block having a plurality of overlying subunits, each subunit comprising sectioned subunits being characterized by predetermined external dimensions, each subunit having substantially similar external dimensions, each subunit comprising a number of overlying food layers and characterized by a stack height,
wherein each subunit is offset with respect to adjacent subunits, such that alternating edges extend laterally outward relative to adjacent subunits to provide a grasping portion,
the grasping portions having a dimension that is sufficient to facilitate manual separation of the subunits from the food block but insufficient to allow the grasping portions to sag out of the plane of the major portion of the subunit, and
wherein the predetermined external dimensions and the stack height of each sectioned subunit substantially correspond with the dimensions of a food receptacle adapted to receive the sectioned subunits.

17. The snack-slice loaf of claim 16, wherein the food block comprises two longitudinal rows of sectioned subunits.

18. The snack-slice loaf of claim 16, wherein the snack-slice loaf comprises two to ten overlying subunits.

19. The snack-slice loaf of claim 16, wherein the snack-slice loaf comprises six overlying subunits.

20. The snack-slice loaf of claim 16, wherein the snack-slice loaf comprises a loaf having a weight of about 2000 grams to about 2200 grams.
